(19) United States
(12) Patent Application Publication
(10) Pub. No.: US 2024/0029585 A1
(43) Pub. Date: Jan. 25, 2024

(54) SURGICAL REPAIR SIMULATION DEVICE

(71) Applicant: The Children's Medical Center Corporation, Boston, MA (US)

(72) Inventors: Carolyn R. Rogers-Vizena, Westwood, MA (US); Michael G. Silver, Ashland, MA (US); Lindsey Minahan, Waltham, MA (US); Stephen F. Wilson, North Easton, MA (US)

(73) Assignee: The Children's Medical Center Corporation, Boston, MA (US)

(21) Appl. No.: 18/352,808

(22) Filed: Jul. 14, 2023

Related U.S. Application Data
(60) Provisional application No. 63/390,557, filed on Jul. 19, 2022.

(51) Int. Cl. G09B 23/30

(52) U.S. Cl. CPC G09B 23/30

(57) ABSTRACT

Surgical simulation devices and their methods of use are described. In some embodiments, a surgical simulation device includes a base, a first surgical model configured to simulate a first cleft lip condition, and a second surgical model configured to simulate a second cleft lip condition. The device includes a model support configured to be releasably engaged with the base. The first surgical model is disposed on a first surface of the model support and the second surgical model is disposed on a second surface of the model support. The base includes an internal volume sized and shaped to receive one of the first surgical model and the second surgical model. The other of the first surgical model and the second surgical model is at least partially exposed when the model support is engaged with the base.

### RELATED APPLICATIONS

This application claims the benefit of priority under 35 U.S.C. § 119(e) of U.S. Provisional Application Ser. No. 63/390,557, filed Jul. 19, 2022, the disclosure of which is incorporated herein by reference in its entirety.

### FIELD

Disclosed embodiments are related to surgical repair simulation devices and related methods of use.

### BACKGROUND

In addition to other surgical procedures, malformation repairs may be critical surgical procedures that may result in a severely problematic immediate and/or chronic patient outcome if the procedure is not performed optimally. For example, various cleft lip conditions may involve improper development of the upper lip and/or palate. Other types of malformation repair may include anorectal malformation repair procedures in addition to other procedures a subject may undergo.

### SUMMARY

In some embodiments, a surgical simulation device may comprise a base, a first surgical model configured to simulate a first cleft lip condition, and a second surgical model configured to simulate a second cleft lip condition. The device may further comprise a model support configured to be releasably engageable with the base. In some embodiments, the first surgical model may be disposed on a first surface of the model support and the second surgical model may be disposed on a second surface of the model support. The base may include an internal volume sized and shaped to receive one of the first surgical model and the second surgical model, and the other of the first surgical model and the second surgical model may be at least partially exposed when the model support is engaged with the base.

In other embodiments, a method of surgical simulation may comprise exposing a first surgical model of a surgical simulation device and performing a first simulated surgical procedure on the first surgical model. The method may further comprise exposing a second surgical model of the surgical simulation device and performing a second simulated surgical procedure on the second surgical model. In some embodiments, at least one of the first and second surgical models may be configured to simulate a cleft lip condition.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a top perspective view of a surgical repair simulation device according to one embodiment;

FIG. 2 is a partially exploded view of the embodiment of FIG. 1;

FIG. 3 is an exploded side view of the embodiment of FIG. 1;

FIG. 4 is a perspective view of a base of a surgical repair simulation device according to one embodiment;

FIG. 5 is a perspective view of a model support of a surgical repair simulation device according to one embodiment;

FIG. 6 is a cross-sectional view of a surgical model according to one embodiment;

FIG. 7 is a perspective view of a surgical model according to one embodiment;

FIG. 8 is a cross-section view of a surgical model disposed on a model support of a surgical repair simulation device according to one embodiment;

FIG. 9A-9D are schematic cross-sectional views of a molding process for a surgical model; and

FIG. 10 is a flow diagram depicting a method of simulating a surgical procedure according to one embodiment.

### DETAILED DESCRIPTION

As noted above, various conditions such as cleft lip or others may require surgical repair. Depending on the nature of the condition and the repair procedure, outcomes from a repair procedure may be critical to patient health and/or appearance. Accordingly, it may be desirable for a surgeon performing a repair procedure to have undergone significant training related to the specific procedure being performed. However, training for some repair procedures may be difficult to obtain because of the relative infrequency of cleft lip conditions. Additionally, live training on a clinical patient may be associated with increased risk to the patient's health and/or appearance depending upon the specific repair procedure to be practiced.

In view of the above, the inventors have recognized and appreciated the benefits associated with a surgical repair simulation device that may provide a physical model on which a cleft lip repair procedure may be simulated. Such a device may allow the steps of a cleft lip repair procedure to be performed, repeated, or practiced on a surgical model without the need for a real patient. This may allow a surgeon to improve the specific skills needed for cleft lip repair and facilitate improvement of patient outcomes.

In some embodiments, a cleft lip surgical model may be configured to be releasably engaged with a base of the device, such that the surgical model may be inserted and removed while the base may be re-used with another surgical model. This modular functionality may reduce costs associated with both the manufacture and use of the device. Furthermore, the modularity may allow a single base to be used with various surgical models simulating different cleft lip conditions, permitting a surgeon to practice a range of cleft lip repair procedures using a single device. As elaborated on further below, in some embodiments, a cleft lip surgical model may also include one or more high fidelity simulated structures disposed within the model to better mimic the properties and functionality of anatomical structures of a subject. This may include, for example, one or more reinforced simulated anatomical structures as described further below.

In some embodiments, at least one surgical model may be provided in a model support of the device. For example, the model support may include various surfaces on which surgical models may be disposed. In some embodiments, the model support may include at least one recess sized and shaped to receive at least a portion of a surgical model. The model support may be configured to be releasably engaged with the base, thereby allowing the surgical model and/or model support to be inserted into or removed from the base. For example, the model support may cooperate with an internal volume of the base, the internal volume being configured to releasably receive at least a portion of the model support and/or surgical model.

The model support may be formed from a rigid material (including plastic materials such as nylon, metals, and/or any other appropriate material) in order to support the surgical model. The model support may be configured to support an operating surface of the surgical model in a desired position and orientation relative to a supporting base of the device when the surgical model is engaged with the base. This may present the surgical model in a desired position and orientation such that a user of the device may perform a simulated surgical procedure on or through the operating surface of the surgical model.

In some embodiments, the device may include a cap. The cap may be configured to cover or contain at least a portion of the surgical model. For example, in some embodiments, a cap may be configured to cover or contain at least an operating surface of the surgical model. Additionally, the cap may be configured to be releasably engaged with a base and/or a model support of the device. In some embodiments, a model support may be releasably engaged with both the base and the cap. In some such embodiments, the model support may be disposed between the base and the cap. In some embodiments, a decoupling force required to disengage the cap from the model support may be less than a decoupling force required to disengage the model support from the base, such that a user may easily remove the cap from the model support without removing the model support from the base.

A surgical repair simulation device according to the various embodiments disclosed herein may also be configured to position and orient a surgical model consistent with the position and orientation of a patient during a cleft lip repair procedure. For example, a base of a device may cooperate with a surgical model or a model support to expose or present the surgical model (or a portion thereof, such as an operating surface) at an angle, position, and/or orientation that simulates an angle, position, and/or orientation of a patient during a surgical procedure. This may further increase an experiential fidelity of the surgical model during training by allowing a surgeon to perform the steps of a procedure at positions and orientations relative to a supporting surface that simulate an operating environment that may be present during an actual procedure where a subject's body may be positioned in a specific orientation relative to the surgeon or other medical practitioner.

A surgical repair simulation device according to the various embodiments disclosed herein may include one or more surgical models configured to simulate any desired malformation. This may include at least one cleft lip malformation selected from: mild, moderate, or severe incomplete unilateral cleft of the left or right side; mild, moderate, or severe complete unilateral cleft of the left or right side; mild, moderate, or severe incomplete or asymmetric bilateral cleft with varying severity right to left or left to right; mild, moderate, or severe complete bilateral cleft; mild, moderate, or severe median cleft lip; or any other appropriate cleft lip condition or combination of cleft lip conditions of any appropriate grade or severity. In addition to a cleft lip surgical model, as noted previously, in some embodiments, a surgical model may correspond to other types of anatomical malformations such as anorectal malformations or other conditions.

In some surgical models it may be desirable to provide a high fidelity anatomical model that closely mimics the properties and behavior of the tissue present within an actual subject. This may improve the ability of a surgeon to practice realistic procedures due to the ability of the materials to be sectioned, sutured, clamped, and/or otherwise manipulated in a fashion that is consistent with the procedure being practiced. In some embodiments, such a surgical model may include one or more reinforced simulated tissues. Depending on the tissue being modeled, these reinforced simulated tissues may be: at least partially encapsulated within a second surrounding simulated tissue; at least partially disposed between separate simulated tissues; include one or more openings formed in the reinforced sections of the tissue layer to simulate one or more anatomical features which are intended to be manipulated, pulled, cut, sutured, or otherwise interacted with (e.g., anatomical lumens, etc.); and/or may include any other desired simulated tissues and/or features. Various constructions and materials related to these simulated tissues are elaborated on further below and in the figures.

As noted above, a surgical model may include various simulated tissues configured to simulate a tissue of a patient. Simulated tissues may include a simulated skin layer, a simulated muscle, a simulated fat layer, a simulated bone, a simulated cartilage, or any appropriate simulated tissue or combination of tissue or tissue layers which may simulate a normal or abnormal anatomy. Each simulated tissue may be formed from any appropriate material for simulating a normal or abnormal portion of a patient's anatomy, including various silicone materials, polyurethane materials, other elastomeric materials, or others. The materials and configurations of each simulated tissue may be selected to enhance a visual, tactile, haptic, or other operational or experiential fidelity of the surgical model. For example, in some embodiments, a simulated tissue may include a reinforcement material, such as: a flexible woven or non-woven fabric, mesh, or web that may either be elastic or substantially inextensible; a porous non-woven material such as a polymer based felt impregnated with a flexible matrix material such as silicone or others. In instances where reinforcement materials are used in a simulated tissue, an appropriate matrix material, such as silicone or others, may be used to encapsulate, impregnate, or otherwise incorporate the reinforcement materials into the desired simulated tissue. The reinforcement material may increase a tactile or haptic fidelity of the surgical model during a simulated procedure, including during a suturing step of the simulated procedure. The disclosed reinforcements may also reduce tearing associated with physical movement, suturing, dissection, or other manipulation of the simulated tissues.

As previously noted, the various embodiments of a surgical model disclosed herein may include simulated skin layers and/or other simulated tissue layers in some embodiments. While any appropriate type of simulated tissue may be used, in some embodiments, a simulated skin layer and/or other simulated tissue layer may include silicone with a durometer reading that is between or equal to Shore 00-0 and Shore A-30. In some embodiments, a simulated skin layer may preferably include silicone with a durometer reading that is between or equal to Shore 00-10 and Shore 00-50. In some embodiments, a simulated tissue layer may preferably include silicone with a durometer reading that is between or equal to Shore 00-0 and Shore 00-30. In some instances, it may be desirable to include one or more reinforcements within a simulated skin layer or other simulated tissue layer. The one or more reinforcements may include any of the reinforcement materials described herein, but in some embodiments, a simulated skin layer may include an elastic reinforcement such as an elastic woven or non-woven fabric, mesh, or web. In one specific embodiment, this may include an elastic nylon mesh. In either case, a reinforcement material may be encapsulated in and extend at least partially across an area of simulated anatomy formed by the silicone. Depending on the particular structure being simulated, a simulated skin layer may have any desired thickness, including a thickness between or equal to 0.5 mm and 3 mm. Alternatively, a thickness of a simulated skin layer may be between or equal to 2.25 mm and 2.75 mm, or more preferably about 2.5 mm. However, other appropriate thicknesses both greater and less than those noted above may also be used as the disclosure is not so limited. A simulated skin layer and/or other tissue may also have appropriate pigmentation to simulate a desired coloration in some embodiments. Appropriate pigments may include various hues of pink, brown, and/or any other appropriate coloration.

The various embodiments of a surgical model disclosed herein may include one or more simulated muscles in some embodiments. While any appropriate type of simulated muscle may be used, in some embodiments, the simulated muscle includes a silicone material with a durometer reading that is between or equal to Shore 00-0 and Shore A-30. The durometer reading of the silicone may preferably be between or equal to Shore 00-10 and Shore 00-50 in some applications. In some instances, it may be desirable to include one or more reinforcements within a simulated muscle. Depending on the specific muscle being simulated, different types of reinforcements may be used to mimic a behavior of the tissue being simulated. For example, certain muscle groups encountered during different surgical procedures may exhibit a different tactile feel to a surgeon during an operation. Accordingly, in some embodiments, the one or more reinforcements may include an elastic reinforcement such as an elastic woven or non-woven fabric, mesh, or web encapsulated in and extending at least partially across an area of simulated muscle formed by the corresponding layer of silicone. In another embodiment, a simulated muscle may correspond to a porous non-woven material impregnated with silicone. For example, this may include a non-woven felt, such as a polyester felt, with one or more desired dimensions (e.g., thickness, length, and width), that has been impregnated with the silicone material. Appropriate thicknesses for the porous non-woven material may be between or equal to 1 mm and 2 mm. Depending on the particular structure being simulated a simulated muscle may have any desired thickness, length, and/or width. While specific dimensions associated with a simulated muscle are described above, other appropriate dimensions both greater and less than those noted above may also be used as the disclosure is not so limited. A simulated muscle may also have appropriate pigmentation to simulate a desired muscle coloration in some embodiments. Appropriate pigments may include various hues of red and/or any other appropriate coloration.

The various embodiments of a surgical model disclosed herein may include a simulated fat layer in some embodiments. Depending on the type of fat and location within the body, fat may exhibit different characteristics. Therefore, in some embodiments, a simulated fat layer may include a silicone material with a durometer reading that is between or equal to Shore 00-0 and Shore A-30. The durometer reading of the silicone may preferably be between or equal to Shore A-0 and Shore A-30 in some applications. In other embodiments, a softer fat layer may be desired. In some embodiments, various additives and/or fillers may optionally be included to provide increased flexibility and/or viscoelastic properties relative to the other simulated tissues. These properties may provide for improved ability to create incisions in and permit retraction of the simulated fat layer during a simulated surgical procedure. Appropriate additives and/or fillers may include but are not limited to: viscosity modifiers (e.g., tactile mutators such as Slacker sold by Reynolds Advanced Materials to provide a desired flesh like feel to the silicone) to modify a viscoelasticity of the simulated tissue (e.g., a simulated fat layer); thickening agents such as THI-VEX®—Thixotropic Agent; fillers such as cornstarch and/or any other appropriate additive and/or filler. In some embodiments, an additive such as mineral oil or others may be included to reduce or control a durometer or tackiness of the silicone. In some embodiments, a simulated fat layer may include silicone with an unmodified durometer reading between or equal to Shore A-0 and Shore A-30 when unmodified by additives and/or fillers.

The various embodiments of a surgical model disclosed herein may include a simulated bone and/or cartilage layer in some embodiments. Appropriate materials for a bone and/or cartilage layer may include rigid polymers such as nylon, polyethylene, polyurethane, and/or any other desired material. The size and/or shape of a simulated bone and/or cartilage layer may be selected based on the desired anatomical features being simulated in a given surgical model. Additionally, in some embodiments, a surgical model may not include any simulated bone and/or cartilage layers.

In view of the above descriptions of the various layers that may be included in a surgical model, the various layers may exhibit different relative tactile feels for a surgeon operating on the surgical model. For example, in the various embodiments described herein, a simulated muscle may exhibit a desired set of characteristics relative to a simulated skin layer. For example, interactions between a simulated muscle and a simulated skin layer may mimic an interaction between an actual muscle and an actual skin layer in terms of the relative rigidity, elasticity, or other visual, tactile, haptic, or operational characteristic, as will be appreciated by one of skill in the art. Correspondingly, a simulated fat layer may be less rigid than both a simulated skin layer and muscle of a surgical model to help simulate the relatively softer feel of fat during a surgical procedure. In embodiments including simulated bone and/or cartilage, the simulated bone and/or cartilage may be more rigid than the corresponding simulated skin, muscle, and fat layers of the surgical model. For example, interactions between or among a simulated fat layer, a simulated cartilage, and/or a simulated bone may mimic an interaction between the various tissues in terms their relative rigidities, elasticities, or other visual, tactile, haptic, or operational characteristics, as will be appreciated by one of skill in the art. Additionally, while specific materials and properties are provided for the various simulated tissues above, it should be understood that simulated tissues including materials and/or properties different from those discussed above are also contemplated as the disclosure is not so limited.

The surgical models disclosed herein are primarily directed to cleft lip malformations. Accordingly, in some embodiments, the surgical models may be sized and shaped to simulate the anatomy of a child and/or infant. However, the disclosure is not limited to only simulating the anatomy of a child. Accordingly, it should be understood that the surgical models disclosed herein may correspond to simulated anatomies of subjects with any appropriate age including, but not limited to, infants, children, juveniles, and adults.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

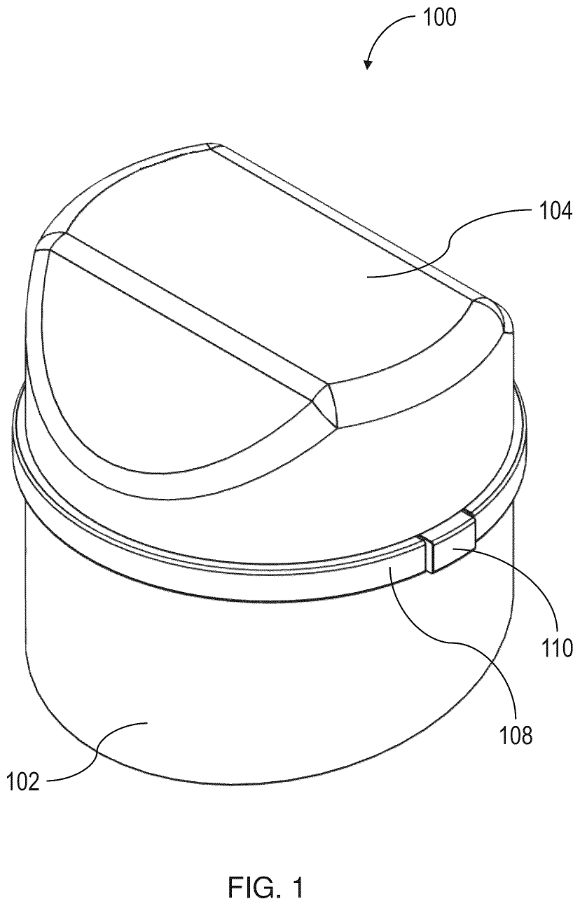

FIGS. 1-3 depict one embodiment of a surgical repair simulation device 100 according to the present disclosure. In some embodiments, a device 100 may include a base 102, a cap 104, a first surgical model 106A disposed on a first side of a model support 108, and a second surgical model 106B disposed on a second side of the model support 108 opposite from the first side. It should be appreciated that although the depicted embodiments frequently include multiple surgical models disposed on a model support, other embodiments may include only a single surgical model. The base may include a lower surface that is configured to rest on an underlying supporting surface to support, retain, orient, and position a surgical model during use and/or storage. Although a cap may not be used in all embodiments, the cap may be configured to releasably engage with the base or the model support to cover at least a portion of a surgical model. Each of the base 102 and the cap 104 may include a respective internal volume configured to releasably receive or engage with at least a portion of the surgical model and/or model support.

The base 102, the cap 104, the model support 108, and/or any subcomponents or portions of each component, may be formed from any appropriate material, including rigid plastic materials such as nylon, polyethylene, polyurethane, acrylonitrile butadiene styrene (ABS), polycarbonate (PC), or any other appropriate plastic or non-plastic material. Each component may be manufactured using any appropriate manufacturing method, including additive manufacturing methods, molding methods, subtractive manufacturing methods (e.g., machining), and/or any other appropriate method or combination of methods.

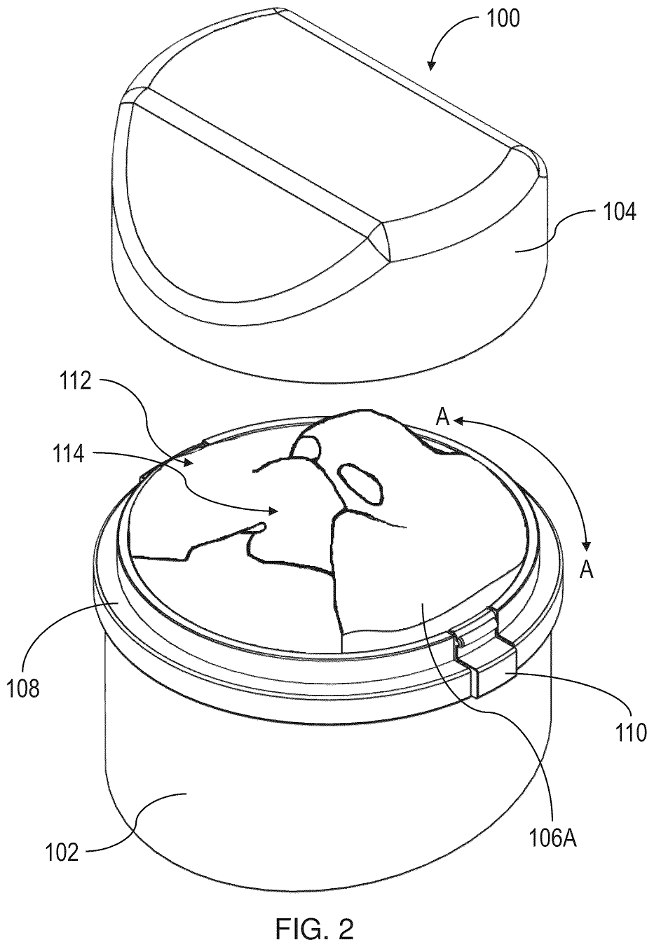

The device 100 may be formed in any appropriate geometry, depending on the embodiment. For example, in the embodiment shown, at least a portion of each of the base 102, the cap 104, and the model support 108 may have a circular cross-section. In some embodiments, the base and cap may each comprise a cylindrical shape, and the model support may comprise a disc shape. The circular cross-section of each component may be coaxial with the circular cross-section of the other components, giving the device 100 a generally cylindrical geometry. The cylindrical geometry of the depicted embodiment may facilitate rotation of a surgical model or model support relative to a base or a cap of the device. For example, as shown in FIG. 2, the cylindrical geometry may facilitate rotation of the model support 108 relative to the base 102 or the cap 104 in the directions indicated by arrow A-A, see FIG. 2. This rotation may enhance an experiential fidelity of the surgical model during training by allowing a surgeon to perform the steps of a procedure at various positions and orientations that may simulate an actual operating environment during a procedure. Although the embodiment shown is depicted as having a cylindrical geometry, it will be appreciated that a device of the present disclosure may have any appropriate geometry, including irregular geometries or geometries which simulate various portions of a patient's anatomy.

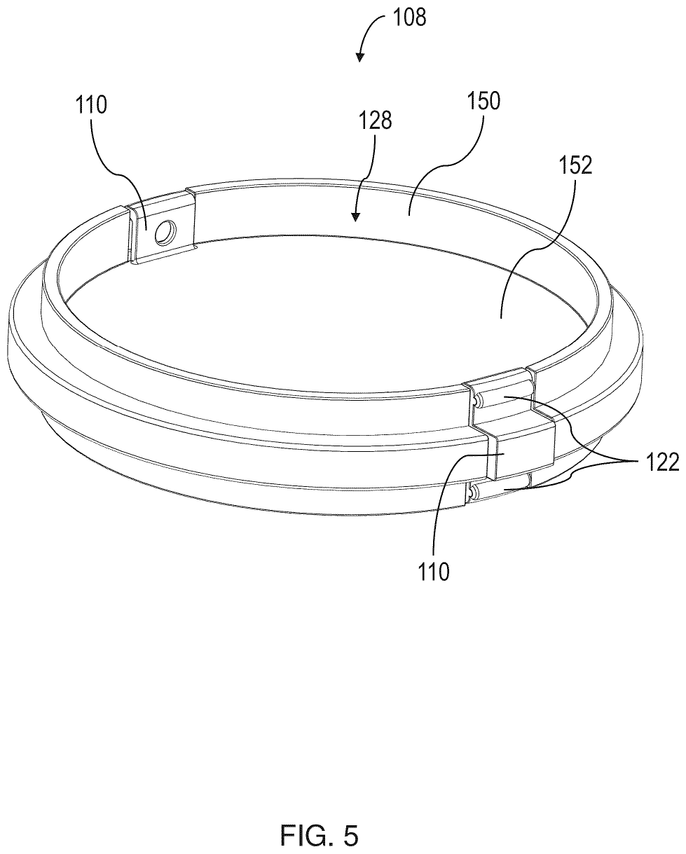

The first surgical model 106A may be configured to be releasably engaged with the base 102 and/or the cap 104, such that the first surgical model 106A may be removed from the device and replaced with another surgical model. In some embodiments, the first surgical model 106A may be provided within or in cooperation with a model support 108. In other embodiments, a surgical model may cooperate or be releasably engaged directly with the base such that no model support may be present. As will be described further with respect to FIG. 5 below, a model support may be a rigid structure that is configured to support at least a portion of a surgical model disposed thereon. In some embodiments, the model support 108 may be configured to be releasably engaged with the base 102, the cap 104, or both the base and the cap. For example, the model support 108 may include one or more releasable connectors 110 configured to cooperate with one or more corresponding releasable connectors of the base 102 and/or the cap 104. In various embodiments, releasable connectors may include cooperating portions of a snap, latch, clip, clamp, detent, spring plunger, magnetic connection, tongue-and-groove fitting, or any other appropriate releasable connector as the disclosure is not limited in this regard.

Further, a surgical model may be configured to simulate a portion of a patient's anatomy to be repaired during a simulated medical procedure. For example, in the embodiment shown, the first surgical model 106A may include a simulated cleft lip 114. In various embodiments, a simulated cleft lip 114 may include mild, moderate, or severe grades of any of appropriate cleft lip condition, including incomplete unilateral cleft of the left or right side; complete unilateral cleft of the left or right side; incomplete or asymmetric bilateral cleft with varying severity right to left or left to right; complete bilateral cleft; median cleft lip; or any other appropriate cleft lip condition or combination of cleft lip conditions of any appropriate grade or severity. For example, in the embodiment shown, the simulated cleft lip 114 may include a mild to moderate complete unilateral cleft of the left side. As will be described further below, the first surgical model 106A and simulated cleft lip 114 may comprise one or more simulated tissues arranged or configured to simulate the desired condition or anatomy.

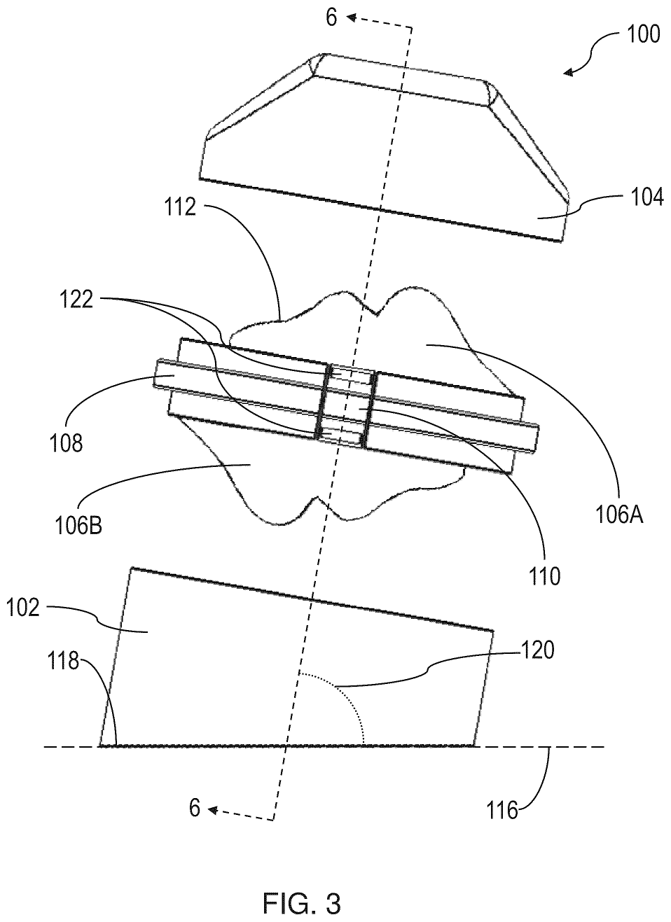

As best shown in FIGS. 2-3, the first surgical model 106A may include an operating surface 112. A surgeon or user may perform a simulated surgical procedure or steps of a simulated surgical procedure on the operating surface 112 or through the operating surface 112. In some embodiments, the base 102, the first surgical model 106A, and/or the model support 108 may be configured to present the operating surface 112 of the surgical model 106 at a position and/or orientation that may simulate a position and/or orientation of a patient during a procedure. In some embodiments and as shown in FIG. 3, the device 100 may be configured to present the operating surface 112 at an angle relative to an underlying surface 116 on which the base 102 may be disposed. In the embodiment shown, a support surface 118 of the base 102 may be angled such that a line 6-6 corresponding to a longitudinal axis of the device 102, which may be perpendicular to the model support in some embodiments, may form an angle 120 with respect to a horizontal plane corresponding to the underlying surface 116. The angled support surface 118 may facilitate the positioning of the surgical model 106A or the operating surface 112 in an orientation which simulates actual operating conditions.

In some embodiments, the angle 120 formed between a longitudinal axis of a surgical repair simulation device and an angled support surface and/or underlying surface the base of the device is disposed on during use may be greater than or equal to 15°, 30°, 45°, 60°, 75° and/or any other appropriate angle. Additionally, the angle may be less than or equal to 90°, 85°, 80°, 60°, 45° and/or any other appropriate angle. Combinations of the foregoing are contemplated including, for example, an angle that is between or equal to 75° and 85°, or more preferably about 80°. Of course, while particular ranges for the angle between the central axis and the underlying surface are provided above, it should be understood that other ranges both greater than and less than those noted above are also contemplated as the disclosure is not limited in this fashion.

In addition to using angled components as described above, a surgical repair simulation device according to the present disclosure may utilize rotation of various components to facilitate simulation of a patient's positioning under actual operating conditions. As previously noted, in some embodiments, a surgical model and/or a model support may be configured to rotate with respect to a base of the device and/or a cap of the device. For example, in the embodiment shown in FIGS. 1-3, the one or more releasable connectors 110 of the model support 108 may be configured to allow rotation of the model support with respect to the base 102 and/or the cap 104. For example, in the depicted embodiment, the releasable connectors 110 of the model support may include one or more tongues 122. Each tongue 122 may be configured to be releasably inserted into corresponding grooves which may be formed in the base and/or the cap.

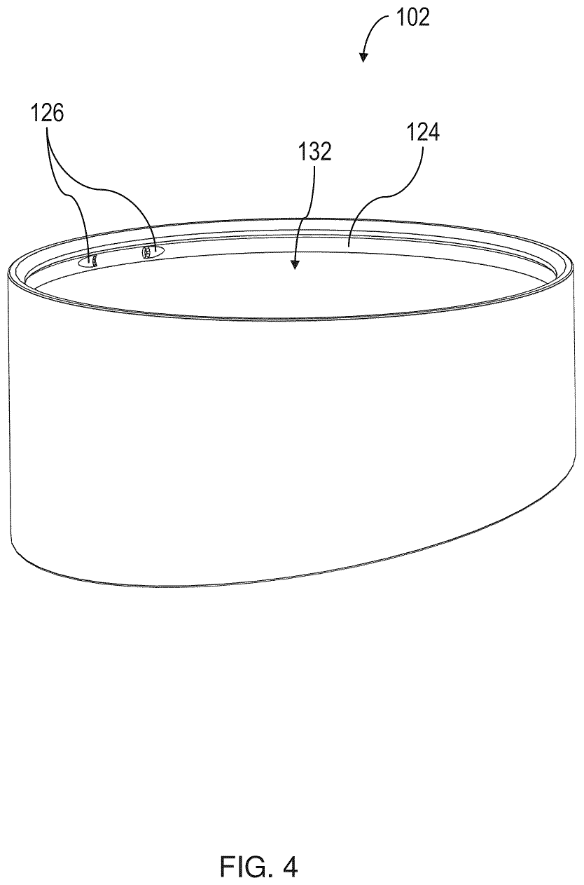

As shown in FIG. 4, the groove 124 may extend around an inner perimeter or inner diameter of the base 102 or the cap 104 (not shown). The groove 124 may be configured to accept the tongue 122 and to allow the tongue to travel along at least a portion of a length of the groove. This relative movement of the tongue 122, or other releasable connector with the groove 124 may permit both rotation and removable engagement between the model support and the base. The groove 124 may optionally include one or more stops 126. The stops 126 may be configured to impede travel of the tongue 122 through the groove 124, such that rotation of the model support 108 and/or surgical model 106 may be at least partially constrained when the tongue 122 is in contact with a stop 126. In some embodiments, the stop 126 may be provided in pairs, such that the motion of a tongue may be at least partially constrained between each stop of the pair of stops. Accordingly, stops or pairs of stops at various points along the groove may facilitate simulation by allowing a user to set a rotational position of the surgical model and by limiting a rotational movement of the surgical model relative to the base during use. While the depicted embodiment illustrates one pair of stops, it will be appreciated that any number of stops may be included where desired, as the disclosure is not limited in this regard. For example, in some embodiments, additional stops may be included to allow a user to select at least one of a first rotational position or a second rotational position of the surgical model, as may be appropriate at various steps in a simulated surgical procedure.

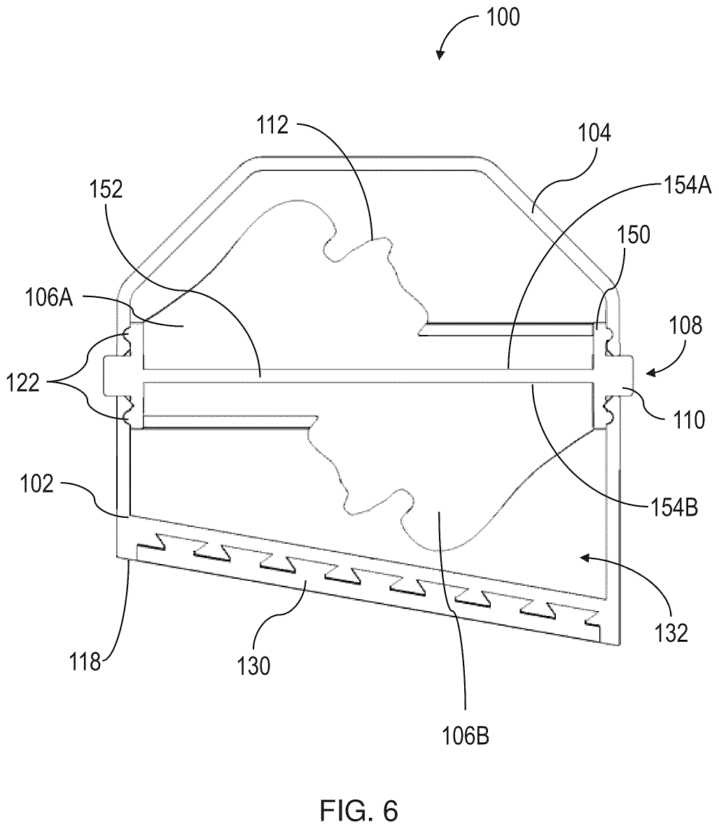

As shown in FIGS. 5-6, the model support 108 may include a support plate 152. In some embodiments, the model support or the support plate may comprise at least one surface on which a surgical model may be disposed. For example, the model support 108 or the support plate 152 thereof may include a first model support surface 154A on which a surgical model may be disposed, and which may be configured to support a surgical model. It will be appreciated that a model support surface need not be formed as part of a support plate, and may be disposed on any appropriate portion of the model support.

In some embodiments, a model support or a support plate thereof may include more than one model support surface. For example, as shown in FIG. 6, the support plate 152 may include both a first surface 154A and a second surface 154B. In some embodiments, a first surgical model 106A may be disposed on the first surface 154A and a second surgical model 106B may be disposed on the second surface 154B. In the embodiment shown, the first and second surfaces 154A, 154B may be disposed on opposite sides of the model support 108, although the surfaces need not be disposed on opposite sides in every embodiment of the disclosed device. In other embodiments, various model support surfaces may be disposed on any appropriate portion of a model support or a support plate thereof.

Additionally, in some embodiments, the model support 108 may include at least one recess sized and shaped to receive at least a portion of a surgical model. In the embodiment shown in FIGS. 5-6, the model support 108 may include a first recess 128 sized and shaped to receive at least a portion of a first surgical model 106A. A recess may be formed within or defined by various portions of a model support, including various plates, surfaces, walls, or other structural features of the model support. For example, in some embodiments and as shown in the figures, the first recess 128 may be formed by the support plate 152 and a wall 150. The wall 150 may extend out from the support plate 152 to define a periphery of the recess. In some embodiments, the wall 150 may be disposed at or near a periphery of the support plate 152 or the model support 108, such that an area of the recess includes a majority of an area of the support plate or the model support. In various embodiments, a wall may be continuous around a periphery of a recess, or the wall may be segmented. For example, in the embodiment shown, the wall 150 may be segmented to accommodate portions of the releasable connectors 110, which may cooperate with the wall 150 to define the periphery of the first recess 128.

In some embodiments, a model support may include more than one recess for receiving and supporting more than one surgical model. For example, in the embodiment shown and as best seen in the cross-sectional view of FIG. 6, a second recess sized and shaped to receive at least a portion of a second surgical model 106B may be included on a second side of the model support 108 opposite a first side. Similar to the first recess described above, the second recess may be formed within or defined by various portions of a model support, including various plates, surfaces, walls, or other structural features of the model support. It should be appreciated that although the embodiment shown includes two recesses for supporting two surgical models, other embodiments may include only a single surgical model disposed within a single recess of a model support and/or model supports where one or more corresponding surgical models are disposed on a non-recessed supporting surface of the model support.

In some embodiments, the base may include an internal volume sized and shaped to receive a portion of a model support and/or a surgical model disposed thereon. For example, in the embodiment shown in FIG. 6, the base 102 may include an internal volume 132. The internal volume 132 may be sized and shaped to receive a portion of the model support 108 as well as a surgical model disposed on the model support. In some embodiments and as shown in FIG. 6, the internal volume 132 may be sized, shaped, or otherwise configured to receive one of the first surgical model 106A and the second surgical model 106B when the model support 108 is engaged with the base 102 such that the other of the first surgical model and the second surgical model is at least partially exposed (or, in some embodiments, retained within an optional cap 104 of the device).

In embodiments which include a cap, a device according to the present disclosure may be configured to allow a cap to be removed without removing the model support from the base. In some embodiments, respective grooves in the cap and the base may be formed with different depths, such that each groove requires a different decoupling force in order to disengage a corresponding tongue from the groove. For example, as best shown in the cross-sectional view of FIG. 6, a groove of the cap 104 may be shallower than a groove of the base 102, such that a decoupling force between the model support 108 and the cap 104 may be less than a decoupling force between the model support 108 and the base 102. Of course, while a tongue and groove releasable connection is shown in the figures, other releasable connections exhibiting the desired different release forces between the cap and base with the model support may also be used as the disclosure is not so limited.

As can as also be seen in FIG. 6, in some embodiments, the support surface 118 of the base 102 may be configured to prevent sliding or movement of the base relative to an underlying surface on which the base may be disposed. For example, in some embodiments, the support surface 118 may optionally include a gripping surface 130 to secure the base 102 relative to an underlying surface. The gripping surface 130 may provide a tacky or frictional engagement between the base and the underlying surface to prevent sliding or movement of the base. In various embodiments, a gripping surface may be disposed on the support surface 118, or within a cavity therein to be flush with the support surface 118 as shown in the non-limiting embodiment of FIG. 6.

The gripping surface 130 may be formed using any appropriate high-friction, tacky, or adhesive material, including a silicone, rubber, polymer, or other appropriate material. For example, in some embodiments, the gripping surface 130 may include an adhesive pad, a double-sided tape, or an elastomeric element integrated into the base. Additionally or alternatively, the gripping surface may include features formed from a rigid material (e.g., plastic, metal etc.) which may be configured to reduce slipping or to prevent the base from sliding across an underlying surface. In some embodiments, a gripping surface may be formed integrally with the base or from the same material as the base. For example, in certain embodiments not shown in the figures, a gripping surface may include a plurality of ridges to create a ribbed texture on the gripping surface, thereby creating a frictional engagement between the base and an underlying surface. Each ridge of the plurality of ridges may comprise an elongate feature raised out from the gripping surface, the plurality being arranged to produce variations in height along a width or length of the gripping surface to create the frictional engagement.

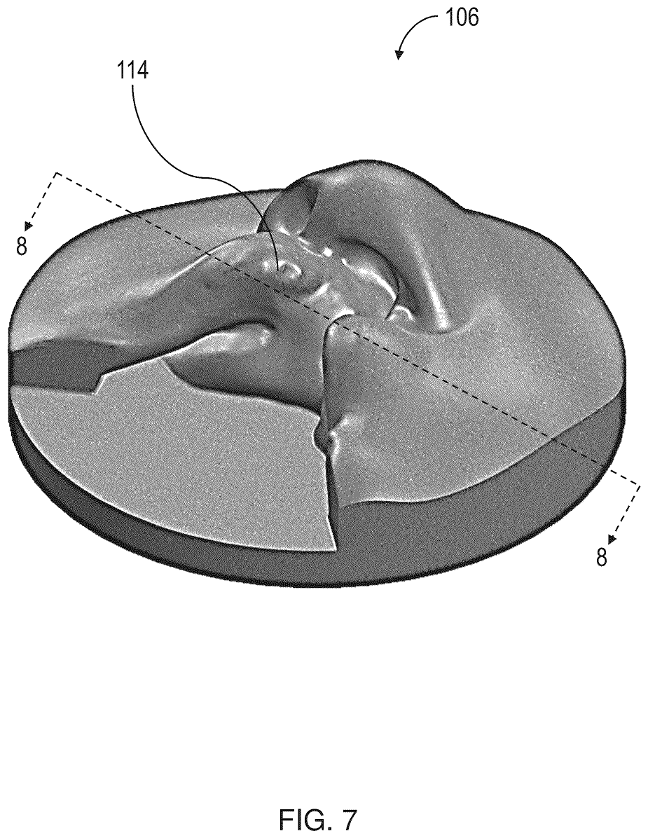

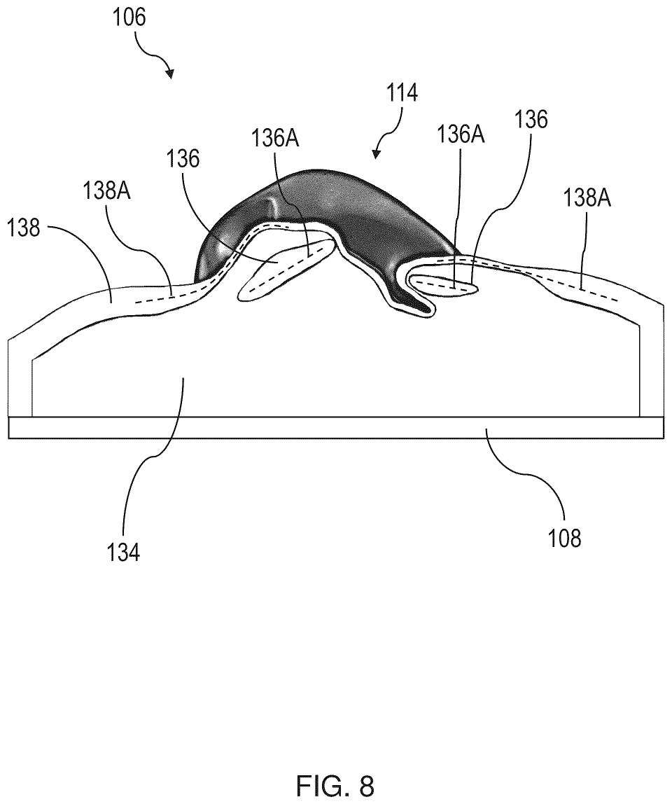

FIG. 7 depicts one embodiment off a cleft lip surgical model 106 including a cleft lip malformation 114. FIG. 8 illustrates a cross section taken through the surgical model of FIG. 7 along line 8-8. As shown in the cross section, the surgical model may include a model support 108 on which the simulated tissues may be disposed. A simulated fat layer 134 may be disposed on the model support and one or more simulated muscles 136 may at least partially, and in some instances completely, encapsulated in the fat layer. In the depicted embodiment, the simulated muscles may include an appropriate muscle reinforcement 136A. As noted above, in some embodiments, the muscle reinforcement may be a porous non-woven material impregnated with a flexible material. For example, a felt material with a desired size and shape may be impregnated with silicone and encapsulated at least partially within the fat layer to provide the desired one or more simulated muscles. The cleft lip surgical model 106 may also include a skin layer 138 disposed on at least a portion, and in some embodiments, all of, an exposed outer surface of the surgical model. To improve the ability of the skin layer to be sutured, dissected, and/or otherwise manipulated during a surgical procedure, the skin layer may include one or more reinforcements 138A disposed therein. For example, an elastic woven fabric, non-woven fabric, mesh, or web may be disposed within a portion of the skin layer that will be operated on during a simulated surgical procedure (e.g., within the portion of the model corresponding to the cleft lip).

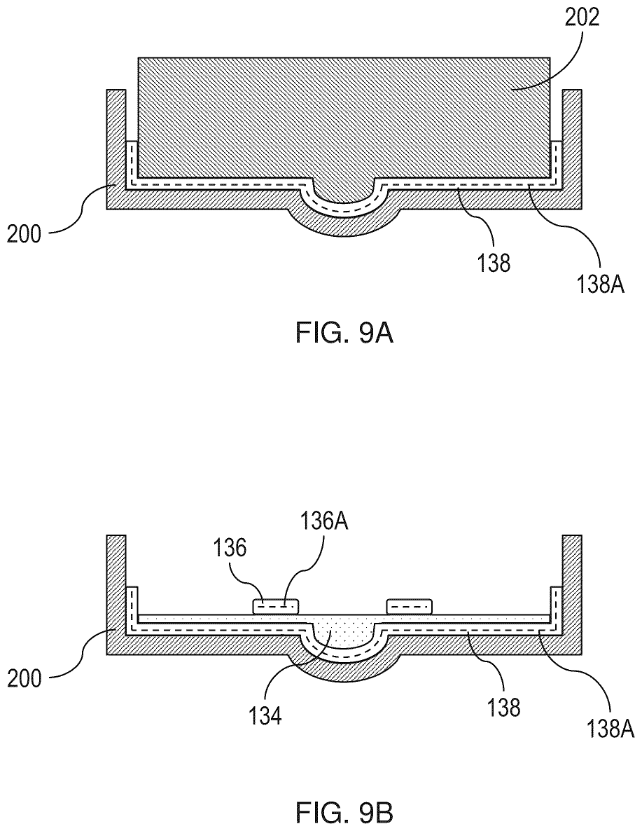

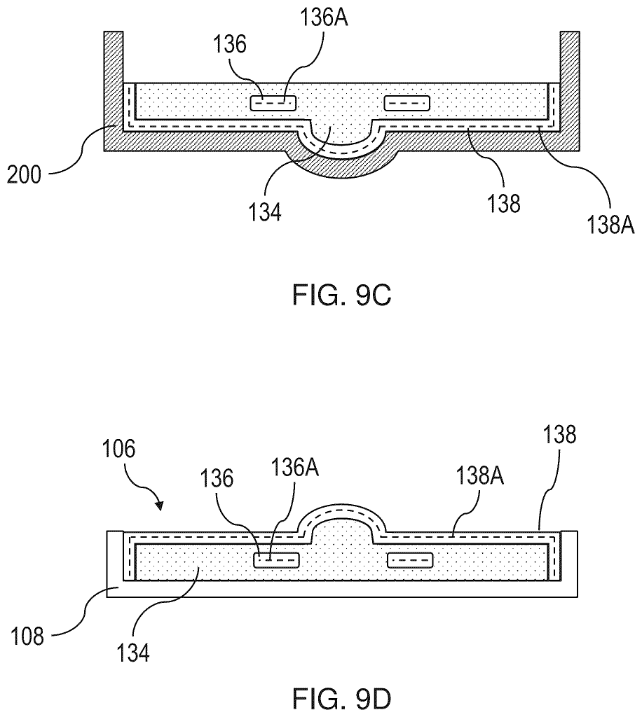

The various surgical models described herein may be manufactured in any appropriate fashion using molding, casting, additive manufacturing, subtractive manufacturing (e.g., cutting and machining), combinations of the forgoing, and/or any other appropriate manufacturing technique. For example, in FIG. 9A, a first mold 200 may be provided in an appropriate shape to mimic the size and shape of a desired condition to be simulated by a surgical model. In the embodiment shown, the first mold 200 may be sized and shaped to form a surgical model simulating a cleft lip condition. A simulated skin layer 138 may be molded in the first mold 200, for example by pouring an appropriate material into the first mold 200. Appropriate materials for the simulated skin layer 138 may include the various elastomeric materials described above, including silicone, polyurethane, or other materials. In some embodiments, a reinforcement material 138A may be included in the simulated skin layer 138. In such embodiments, the reinforcement material 138A may be laid within the first mold 200 at any appropriate point in the molding process, including before, after, or while the skin layer 138 is poured into the first mold 200. A second mold 202 may be used to form an interior side of the simulated skin layer 138. The second mold 202 may be formed in any appropriate size or shape, depending on the malformation being simulated in a given embodiment. The second mold may be pressed into the simulated skin layer 138, such that the shape of the skin layer 138 may be formed between the first mold and the second mold.

In FIG. 9B, a first portion of a simulated fat layer 134 has been poured or otherwise disposed within the first mold and allowed to cure. In the embodiment shown, the first portion of the simulated fat layer 134 is disposed on a side of the simulated skin layer 138 opposite the first mold 200. Accordingly, the side on which the simulated fat layer is poured may be an interior portion of the surgical model being formed. Additionally, FIG. 9B depicts the inclusion of at least one simulated muscle 136. In embodiments of the depicted process which include at least one simulated muscle, it may be desirable to allow at least the first portion of the simulated fat layer to cure prior to introducing the simulated muscle(s) in order to prevent intermixing of the various layers and to retain the distinct material properties of each layer. In some embodiments, each simulated muscle 136 may be formed separately using any appropriate method, including separate molding processes or other manufacturing methods. In some embodiments, each simulated muscle 136 may be formed from the various elastomeric materials described above, including silicone, polyurethane, or other materials. Additionally, each simulated muscle 136 may optionally include a reinforcement material 136A. The reinforcement material 136A may be formed from the various materials described above, including a flexible woven or non-woven fabric, mesh, or web that may either be elastic or substantially inextensible; a porous non-woven material such as a polymer based felt impregnated with a flexible matrix material such as silicone or others. In instances in which a simulated muscle(s) 136 is impregnated with another material, the porous material(s) may be placed in one or more desired locations within the mold cavity on the cured first portion of the fat layer. A separate molding process may then be used impregnate a desired elastomeric material into the porous material of the simulated muscle.

The simulated muscle(s) 136 may be placed between a first portion and a second portion of the simulated fat layer in order to suspend or encapsulate the simulated muscle(s) within the simulated fat layer 134. For example, in some embodiments, after the simulated muscle(s) 136 have been placed in the mold (either with or without a reinforcement material), a second portion of the simulated fat layer 134 may be poured over the simulated muscle(s) 136. The first and second portions of the simulated fat layer may thereby encapsulate the simulated muscle(s) 136 within the simulated fat layer 136. Of course, depending on a desired placement of simulated muscles, any number of portions may be used for the simulated fat layer (or for any simulated tissue layer in which another layer may be suspended or encapsulated). For example, a first simulated muscle may be placed following a first portion of simulated fat, and a second simulated muscle may be placed following a second portion of simulated fit, such that the first and second simulated muscles are offset from each other in at least one direction.

As shown in FIG. 9C, a second portion of the simulated fat layer 134 may be used to fully encapsulate the simulated muscles 136. However, it will be appreciated that in other embodiments, the simulated muscles 136 may be only partially encapsulated within the simulated fat layer or other simulated tissue layer. For example, in some embodiments, the second portion of the simulated fat layer 134 may rise to be flush with a surface of the simulated muscles 136, such that both the simulated muscles and the simulated fat layer may be exposed at the top of the mold. In FIG. 9D, the surgical model 106 has been removed from the first mold 200 and installed into a model support 108 as previously described.

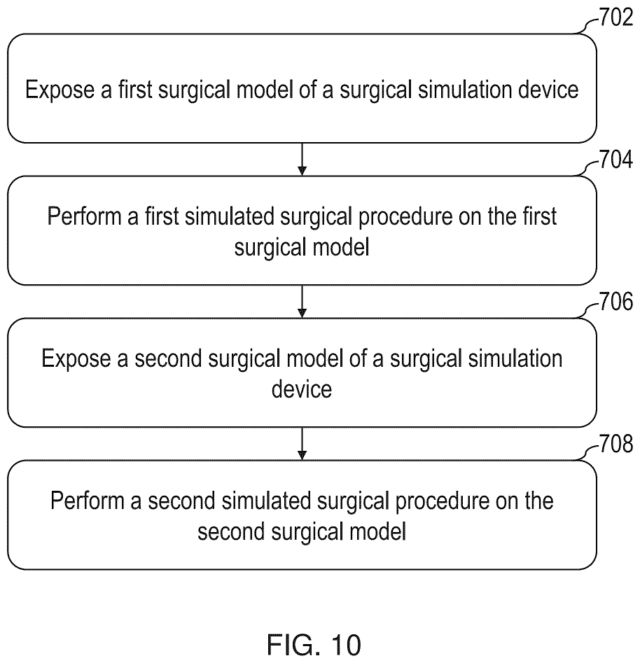

FIG. 10 depicts a method of surgical simulation according to the present disclosure. At step 702, a first surgical model of a surgical repair simulation device may be exposed. In some embodiments, the first surgical model may be configured to simulate a cleft lip malformation, including: mild, moderate, or severe incomplete unilateral cleft of the left or right side; mild, moderate, or severe complete unilateral cleft of the left or right side; mild, moderate, or severe incomplete or asymmetric bilateral cleft with varying severity right to left or left to right; mild, moderate, or severe complete bilateral cleft; mild, moderate, or severe median cleft lip; or any other appropriate cleft lip condition or combination of cleft lip conditions of any appropriate grade or severity. In some embodiments, exposing a first surgical model of a repair simulation device may comprise removing a cap of the device from a base and/or a model support of the device on which the first surgical model may be disposed. Additionally, in some embodiments, removing the cap may comprise applying a first decoupling force to remove the cap from the model support, the first decoupling force being less than a second decoupling force required to remove the model support from the base. In some embodiments, a third decoupling force between the base and an underlying surface on which the base rests (e.g., a peel force between the underlying surface and a gripping surface of the base such as an adhesive pad or material) may optionally be greater than both the first and second decoupling forces. Step 702 may additionally or alternatively include inserting the first model support into the base. In some embodiments, the base may include an internal volume configured to releasably receive a surgical model or model support. Inserting a first surgical model or first model support may include releasably engaging the first surgical model or first model support, for example using one or more releasable connectors as described above.

At step 704, a first simulated surgical procedure may be performed on the first surgical model. This may include performing one or more simulated procedure steps on one or more simulated tissues of the first surgical model. As described above, the one or more simulated tissues may include at least one of a simulated skin layer, a simulated muscle, a simulated fat layer, a simulated bone or cartilage, any combination thereof, and/or any other appropriate simulated tissue layer. In embodiments which include the use of a reinforcement material in one or more simulated tissues, performing the first simulated surgical procedure or performing the one or more simulated procedure steps may include dissection and/or suturing of one or more of the simulated tissues in an area that includes the reinforcement material.

At step 706, a second surgical model may be exposed. In various embodiments, the second surgical model may be disposed on a second model support or on a second side of the first model support, the second side being opposite a first side of the first model support on which the first surgical model may be disposed. Accordingly, step 208 may optionally include inserting a second model support into the base, or into an internal volume of the base. Inserting a second surgical model or second model support may include releasably engaging the second surgical model or second model support, for example using the one or more releasable connectors of the base (or internal volume of the base) in conjunction with one or more releasable connector points of the second surgical model or second model support as described above. Alternatively, step 208 may optionally include turning the first model support to expose the second side and re-inserting the first model support to expose the second surgical model. In some embodiments, the second surgical model may be configured to simulate a cleft lip malformation, including: mild, moderate, or severe incomplete unilateral cleft of the left or right side; mild, moderate, or severe complete unilateral cleft of the left or right side; mild, moderate, or severe incomplete or asymmetric bilateral cleft with varying severity right to left or left to right; mild, moderate, or severe complete bilateral cleft; mild, moderate, or severe median cleft lip; or any other appropriate cleft lip condition or combination of cleft lip conditions of any appropriate grade or severity. It will be appreciated that the first and second surgical models may be configured to simulate the same malformation or different malformations.

At step 708, a second simulated surgical procedure may be performed on the second surgical model. It will be appreciated that the first and second simulated surgical procedures may be the same procedures or different procedures. The second simulated surgical procedure may include performing one or more simulated procedure steps on one or more simulated tissues of the second surgical model. As described above, the one or more simulated tissues may include at least one of a simulated skin layer, a simulated muscle, a simulated fat layer, another simulated tissue layer, or any combination thereof.

Some methods according to the present disclosure may further comprise positioning a surgical model at an angle relative to an underlying surface on which the base is disposed that simulates a position of a patient during a surgical procedure. For example, a surgical model may be positioned such that an angle between a central axis of the device and the underlying surface may be formed as described above. Some methods may further comprise positioning the surgical model at a rotational position within the device that simulates a position of a patient during a surgical procedure. For example, a surgical model may be rotated in relation to a base of the device such that the surgical model is presented at a desired orientation during a simulated procedure. These positional adjustments may be carried out before or during any step of the methods described herein, including during the simulated surgical procedures to re-orient the surgical model during the procedure.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A surgical simulation device, comprising:
a base;
a first surgical model configured to simulate a first cleft lip condition;
a second surgical model configured to simulate a second cleft lip condition; and
a model support configured to be releasably engaged with the base, the first surgical model disposed on a first surface of the model support and the second surgical model disposed on a second surface of the model support, the base including an internal volume sized and shaped to receive one of the first surgical model and the second surgical model, wherein the other of the first surgical model and the second surgical model is at least partially exposed when the model support is engaged with the base.

2. The device of claim 1, wherein the first and second cleft lip conditions are the same cleft lip condition.

3. The device of claim 1, wherein the first surface is disposed on a first side of the model support, and the second surface is disposed on a second side of the model support opposite the first side.

4. The device of claim 1, wherein the internal volume is sized and shaped to receive at least a portion of the model support.

5. The device of claim 1, wherein the base comprises a cylindrical shape and wherein the model support comprises a disc shape.

6. The device of claim 1, further comprising a cap, wherein the model support is configured to be releasably engaged with both the base and the cap with the model support disposed between the base and the cap.

7. The device of claim 6, wherein a decoupling force between the model support and the cap is less than a decoupling force between the model support and the base.

8. The device of claim 1, wherein the device is configured to present the first surgical model at an angle relative to an underlying surface the base is disposed during use, the angle being configured to simulate a position of a patient during a surgical procedure.

9. The device of claim 8, wherein an angle between a longitudinal axis of the device and the underlying surface is between or equal to 75° and 85° during use.

10. The device of claim 1, wherein the model support is configured to rotate with respect to the base while the model support is releasably engaged with the base.

11. The device of claim 10, wherein the base comprises at least one groove configured to releasably engage with a tongue of the model support, wherein the at least one groove is further configured to allow rotation of the model support with respect to the base by allowing the tongue to travel along the at least one groove.

12. The device of claim 1, wherein the base includes a gripping surface on a supporting surface of the base.

13. The device of claim 1, wherein the first surgical model is configured to simulate a cleft lip condition selected from: mild, moderate, or severe incomplete unilateral cleft of the left or right side; mild, moderate, or severe complete unilateral cleft of the left or right side; mild, moderate, or severe incomplete or asymmetric bilateral cleft with varying severity right to left or left to right; or mild, moderate, or severe complete bilateral cleft; mild, moderate, or severe median cleft lip.

14. The device of claim 1, wherein the first surgical model comprises one or more simulated tissues.

15. The device of claim 14, wherein the one or more simulated tissues includes at least one selected from a simulated skin layer, a simulated muscle, and a simulated fat layer.

16. The device of claim 14, wherein at least one of the simulated tissues comprises a silicone material.

17. The device of claim 16, wherein at least one of the simulated tissues further comprises at least one reinforcement material.

18. The device of claim 17, wherein the at least one reinforcement material is selected from an elastic woven fabric, a porous non-woven fabric, a porous non-woven fabric impregnated with a flexible matrix material, a mesh, or a web.

19. A method of surgical simulation, the method comprising:
exposing a first surgical model of a surgical simulation device;
performing a first simulated surgical procedure on the first surgical model;
exposing a second surgical model of the surgical simulation device; and
performing a second simulated surgical procedure on the second surgical model,
wherein at least one of the first and second surgical models is configured to simulate a cleft lip condition.

20. The method of claim 19, wherein exposing the first surgical model comprises providing a model support of the surgical simulation device releasably engaged with a base of the device, the first and second surgical models being at least partially disposed on the model support, and wherein exposing the second surgical model comprises releasing the model support from the base and releasably re-engaging the model support with the base.

21. The method of claim 20, wherein providing the model support releasably engaged with the base comprises providing the model support with the first surgical model disposed on a first side of the model support and the second surgical model disposed on a second side of the model support opposite the first side, the second surgical model being provided at least partially disposed within an internal volume of the base, and wherein releasably re-engaging the model support with the base includes turning the model support over to:
expose the second surgical model, and
at least partially dispose the first surgical model within the internal volume of the base.

22. The method of claim 21, wherein releasing the model support from the base comprises releasing a first tongue of the model support from a groove of the base and wherein releasably re-engaging the model support with the base further comprises releasably engaging a second tongue of the model support with the groove, the first and second tongue being disposed on opposing first and second sides of the model support.

23. The method of claim 19, wherein at least one of the first and second surgical models is configured to simulate the cleft lip condition selected from: mild, moderate, or severe incomplete unilateral cleft of the left or right side; mild, moderate, or severe complete unilateral cleft of the left or right side; mild, moderate, or severe incomplete or asymmetric bilateral cleft with varying severity right to left or left to right; or mild, moderate, or severe complete bilateral cleft; mild, moderate, or severe median cleft lip.

24. The method of claim 19, wherein performing the first or second simulated surgical procedures comprises performing one or more simulated procedure steps on one or more simulated tissues of the first or second surgical model.

25. The method of claim 24, wherein performing the one or more simulated procedure steps on the one or more simulated tissues of the first or second surgical model includes performing the one or more simulated procedure steps on at least one selected from a simulated skin layer, a simulated muscle, and a simulated fat layer.

26. The method of claim 24, wherein at least one of the simulated tissues comprises a silicone material and a reinforcement material.
